(19) United States
(12) Patent Application Publication
(10) Pub. No.: US 2017/0326919 A1
(43) Pub. Date: Nov. 16, 2017

(54) PNEUMATIC VEHICLE TIRE

(71) Applicant: CONTINENTAL REIFEN DEUTSCHLAND GMBH, Hannover (DE)

(72) Inventor: Torsten Heinhaupt, Hambühren (DE)

(73) Assignee: CONTINENTAL REIFEN DEUTSCHLAND GMBH, Hannover (DE)

(21) Appl. No.: 15/527,722

(22) PCT Filed: Nov. 11, 2015
(86) PCT No.: PCT/EP2015/076280

§ 371 Date: May 18, 2017

(30) Foreign Application Priority Data
Jan. 13, 2015 (DE) 10 2015 200 360.4

(51) Int. Cl. B60C 11/13; B60C 11/11; B60C 11/12; B60C 11/03

(52) U.S. Cl. CPC B60C 11/1307; B60C 11/11; B60C 2011/1213; B60C 11/0306; B60C 2011/0353; B60C 2011/1338; B60C 2011/0365

(57) ABSTRACT

Pneumatic vehicle tyre having a tread with at least one block row (1, 2, 3) which runs around in the circumferential direction and is separated from further profile positives by at least one circumferential groove (7, 8), and the profile blocks (1a, 2a, 3a) of which are separated from one another in the circumferential direction by transverse grooves (4, 5, 6) and have block edges (10, 11, 12, 11′, 12′) which bound the at least one circumferential groove (7, 8) and transverse grooves (4, 5, 6) and extend at an angle (a) of 0° to 10° with respect to the radial direction. Projections (13, 14) are formed along block edges (10, 11, 12, 11′, 12′), radially inside the block surface forming the tread surface, said projections (13, 14) having a surface (13a, 14a) which runs parallel to the block surface and having an edge extending parallel to the block edge (10, 11, 12, 11′, 12′) at a distance (a2) of 0.3 mm to 1.0 mm, from which edge an end face (13b, 14b), which bounds the projection (13, 14), runs as far as the groove base, said end face (13b, 14b) running at an angle with respect to the radial direction which is up to 7° larger than that of the respective block edge (10, 11, 12, 11′, 12′).

The invention relates to a pneumatic vehicle tire having a tread with at least one row of blocks, which runs around in the circumferential direction, is separated from further profile positives by at least one circumferential groove and the profile blocks of which are separated from one another in the circumferential direction by transverse grooves and have block flanks which bound the at least one circumferential groove and transverse grooves and extend at an angle of 0° to 10° in relation to the radial direction.

Pneumatic vehicle tires designed in such a way are known in different design variants. The treads of the pneumatic vehicle tires may be made up of rows of profile blocks or comprise a combination of rows of profile blocks and profile positives or profile strips running around in the manner of bands. Pneumatic vehicle tires that are intended in particular for use on light trucks, pickups and the like and are intended to be especially suitable for use on snow, slush, off-road, on other muddy ground or grass, usually have a tread with a pronounced block structure Such tires are intended to have good handling, traction and braking properties on the types of ground mentioned and at the same time be of a robust design, in order to stop them from undergoing increased or premature wear or damage.

The invention is based on the object of improving a pneumatic vehicle tire of the type mentioned at the beginning that is suitable for the intended purpose mentioned on light trucks, pickups and the like, and in particular on special types of ground, such as snow, slush, other mud and the like, with regard to its handling, braking and traction properties and also its service life.

The stated object is achieved according to the invention by projections being formed along block flanks, radially within the block surface, which projections have a surface running parallel to the block surface with an edge extending parallel to the block flank and at a distance of 0.3 mm to 1.0 mm, from which an end face bounding the projection runs as far as the base of the groove and runs at an angle in relation to the radial direction up to 7° greater than the respective block flank.

Treads designed according to the invention therefore have blocks with block flanks on which flat projections formed along the block flanks are provided. Provided along peripheral edges of the surface of the projections are additional “traction edges”, which improve the traction of the tread on soft ground, such as snow, mud, grass, sand and the like. In addition, the projections stabilize the respective profile block, so that the handling and braking properties are also favorably influenced. The projections also offer protection from damage and premature wear of the profile blocks caused by sharp stones and the like penetrating into the grooves.

According to a preferred embodiment of the invention, the distance of the edge extending parallel to the block flank from the block flank is 0.4 mm to 0.6 mm. The projections are therefore so flat that they do not impair the water drainage ability of the circumferential and transverse grooves.

The surface of the projections preferably runs at a distance of 1.5 mm to 2.5 mm from the respective block surface, in order to provide such optimally positioned traction edges on soft ground.

In the case of a further preferred embodiment of the invention, the projections have a longitudinal extent of 4 mm to 20 mm in the direction of the extent of the respective transverse groove or circumferential groove. In the case of designs with a shorter longitudinal extent, two or more projections may be formed per block flank. Particularly effective here are such projections that have a relatively great extent along the groove concerned, such projections preferably being provided on block flanks that bound transverse grooves.

For balanced stability of the profile positives, it is also advantageous if there is opposite a projection on one block flank of a profile block a projection on the opposite block flank of a profile block that is adjacent in the circumferential or transverse direction.

Further features, advantages and details of the invention are now described in more detail on the basis of the drawing, which schematically shows exemplary embodiments of the invention. Here,

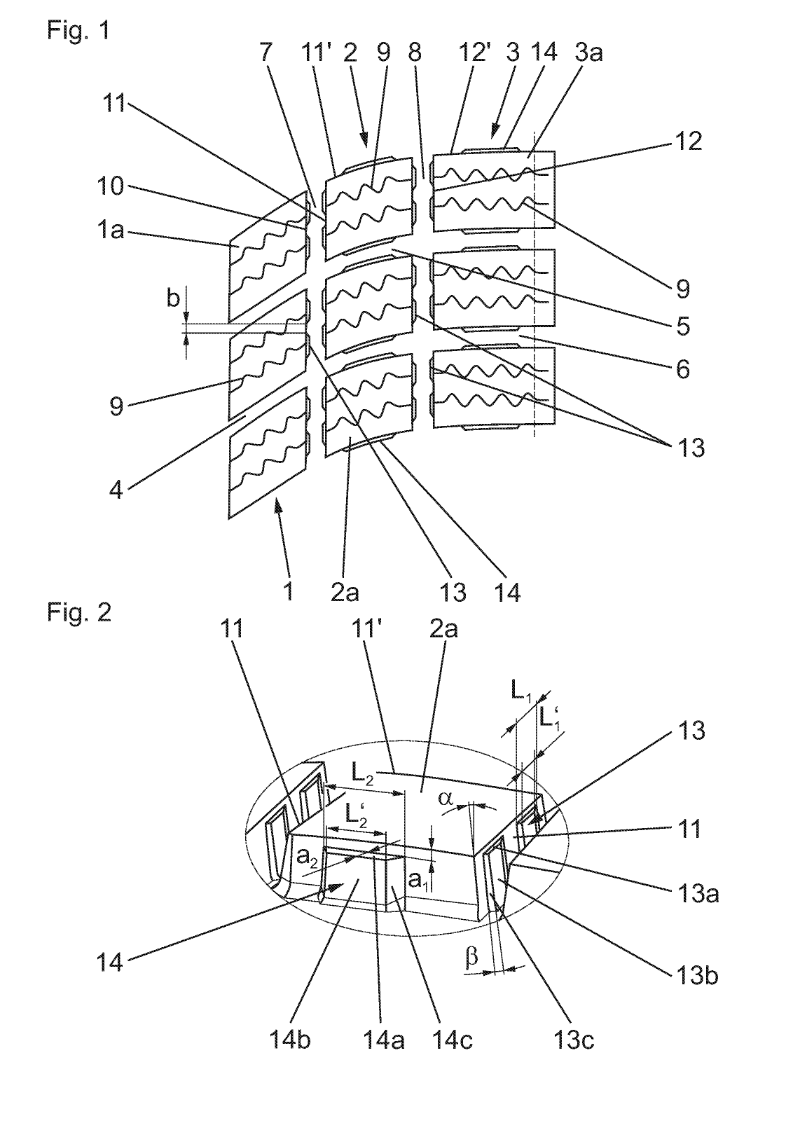

FIG. 1 shows a plan view of some profile blocks in the tread of a pneumatic vehicle tire and

FIG. 2 shows a view of a profile block of a tread of a pneumatic vehicle tire.

The invention is concerned with the configuration of a tread for pneumatic vehicle tires of a radial type of construction, in particular for tires for passenger cars and light trucks, such as pickups. Pneumatic vehicle tires designed according to the invention are especially intended and particularly well suited for use in wintry driving conditions, such as snow, slush or ice, but also for use on mud, grass, sand and the like.

FIG. 1 schematically shows three rows of blocks running around in one of the halves of the tread, a central row of blocks 1, a middle row of blocks 2 and a shoulder-side row of blocks 3. In the row of blocks 3, the dashed line symbolizes the lateral periphery of the ground contact area of the tread. Each row of blocks 1, 2 and 3 is made up of profile blocks 1a, 2a and 3a that are in series with one another in the circumferential direction and are separated from one another within each row of blocks 1, 2, 3 by transverse grooves 4, 5 and 6. Transverse grooves are understood within the scope of the invention as meaning grooves which have a direction of extent that deviates from the axial direction by up to 45°. In the case of the embodiment shown, the transverse grooves 6 in the shoulder-side rows of blocks 3 run at a smaller angle in relation to the axial direction than the transverse grooves 4 running in the central row of blocks 1. The middle row of blocks 2 is separated from the central row of blocks 1 and from the shoulder-side row of blocks 3 in each case by a circumferential groove 7, 8 running around in the circumferential direction of the tread. In the case of the simplified embodiment shown, the circumferential grooves 7, 8 are grooves running around straight in the circumferential direction, but they may also run in a zigzag or wavy form, and therefore have portions that are inclined in particular by an angle of <45° with respect to the circumferential direction. A number of sipes 9 are respectively formed in the profile blocks 1a, 2a and 3a. In the case of the embodiment shown, all of the sipes 9 are sipes that run in a wavy or zigzag form, cross the profile blocks 1a, 2a, 3a and have a width of in particular 0.4 mm to 0.6 mm.

The circumferential groove 7 is bounded on one side by block flanks 10 of the profile blocks 1a and on the other side by block flanks 11 of the profile blocks 2a, the circumferential groove 8 is bounded by block flanks 11 of the profile blocks 2a and block flanks 12 of the profile blocks 3a. Block flanks 11′ of the profile blocks 2a bound the transverse grooves 5, block flanks 12′ of the profile blocks 3a bound the transverse grooves 6. The block flanks 10, 11, 12, 11′ and 12′ form an included angle α with the radial direction of from 0° to 10° (FIG. 2), preferably of approximately 4°, in such a way that the width of the circumferential grooves 7, 8 and of the transverse grooves 5, 6 at the respective base of the groove is somewhat smaller than at the surface of the tread.

Two projections 13 are respectively formed on the block flanks 10, 11, 12 bounding the circumferential grooves 7, 8, one projection 14 is respectively formed on the block flanks 11′ and 12′, which bound the transverse grooves 5, 6. The arrangement of the projections 13, 14 is preferably such that they respectively lie opposite one another in pairs on opposite block flanks 10, 11, 12, 11′, 12′. The projections 13, 14 run along the block flanks 10, 11, 12, 11′, 12′, beginning at a distance a₁ of 1.5 mm to 2.5 mm, in particular 2 mm, from the respective block surface as far as the respective base of the groove. The projections 13, 14 respectively have surfaces 13a, 14a with an edge running parallel to the block flank 10, 11, 12, 11′, 12′ at a distance a₂ of 0.3 mm to 1.0 mm, in particular 0.4 mm to 0.6 mm, from which an end face 13b, 14b running at an angle β of up to 7°, in particular up to 5°, in relation to the respective block flank 10, 11, 12, 11′, 12′ runs up to the respective base of the groove. Narrow side faces 13c, 14c run in the radial direction between the end face 13b, 14b and the respective block flank 10, 11, 12, 11′, 12′. The surfaces 13a, 14a are elongate rectangles, in particular substantially equilateral trapezoids, and run parallel to the surfaces of the profile blocks. The longer trapezoid baseline is located on the respective block flank 10, 11, 12, 11′, 12′, the shorter baseline of the trapezoid form runs parallel to the respective block flank 10, 11, 12, 11′, 12′ and is that edge from which the end face 13b, 14b extends. The greatest longitudinal extent L₁ of the projections 13—along the extent of the respective circumferential groove 7, 8—is 4 mm to 10 mm, the longitudinal extent L₁′ of that edge at which the end face 13b adjoins may be up to 3 mm shorter. The mutual distance b between the projections 13 arranged in pairs on the block flanks 10, 11 and 12 is at least 2 mm, their distance from the respective block corners is at least 1 mm.

The projections 14 on the block flanks 11′ and 12′ have a longitudinal extent L₂ along the block flanks 11′, 12′ that is in particular 10 mm to 20 mm, the longitudinal extent L₂′ at that edge at which the end face 14b adjoins may be up to 3 mm less than L₂.

The bounding edges of the surfaces 13a, 14a act as “traction edges” and contribute to an improvement in the positive engagement of the tread with soft ground, such as snow, mud, sand and the like. The inclination of the end faces 13b, 14b of the projections 13, 14, which is greater than the inclination of the block flanks 10, 11, 12, 11′, 12′ in relation to the radial direction, brings about a particularly advantageous stabilization of the profile blocks 1a, 2a, 3a by the projections 13, 14. The rubber material of the projections 13, 14 also protects the profile blocks 1a, 2a, 3a from being cut into or damaged, in particular by sharp stones and the like.

The invention is not restricted to the embodiments shown and described. Thus, for example, the projections may have transitional areas of a rounded design between the end faces and the respective block flank.

### LIST OF REFERENCE NUMBERS

1, 2, 3 . . . Row of blocks
1a, 2a, 3a . . . Profile block
4, 5, 6 . . . Transverse groove
7, 8 . . . Circumferential groove
9 . . . Sipe
10 . . . Block flank
11, 11′ . . . Block flank
12, 12′ . . . Block flank
13, 14 . . . Projection
13a, 14a . . . Surface
13b, 14b . . . End face
13c, 14c . . . Side face
a₁, a₂, b . . . Distance
L₁, L₁′ . . . Longitudinal extent
L₂, L₂′ . . . Longitudinal extent
α, β . . . Angle

1.-6. (canceled)

7. A pneumatic vehicle tire comprising a tread having at least one row of blocks, which runs around in a circumferential direction of the pneumatic vehicle tire, the at least one row of blocks separated from further profile positives by at least one circumferential groove, and further comprising a plurality of profile blocks within each of the at least one row of blocks, wherein profile blocks are separated from one another in the circumferential direction by transverse grooves and have block flanks which bound the at least one circumferential groove and the transverse grooves, and wherein the block flanks extend at an angle (α) of from 0° to 10° in relation to a radial direction of pneumatic vehicle tire; and,
wherein projections are formed along the block flanks, radially within surfaces of the block flanks, and wherein the projections have surfaces running parallel to the surfaces of the block flanks with edges extending parallel to the block flanks and at a distance (a2) of from 0.3 mm to 1.0 mm, from which end faces bounding the projections run as far as the base of the groove and run at an angle in relation to the radial direction up to 7° greater than the respective block flank.

8. The pneumatic vehicle tire as claimed in claim 7, wherein a distance (a2) of the edges from the block flanks is from 0.4 mm to 0.6 mm.

9. The pneumatic vehicle tire as claimed in claim 7, wherein the surfaces of the projections run at a distance (a1) of from 1.5 mm to 2.5 mm from the respective block surface.

10. The pneumatic vehicle tire as claimed in claim 7, wherein the projections have a longitudinal extent (L1, L2) of from 4 mm to 20 mm in the direction of the extent of the respective transverse groove.

11. The pneumatic vehicle tire as claimed in claim 7, wherein the projections have a longitudinal extent (L1, L2) of from 4 mm to 20 mm in the direction of the extent of the respective circumferential groove.

12. The pneumatic vehicle tire as claimed in claim 7, wherein there is opposite a projection on one block flank of a profile block, a projection on the opposite block flank of a profile block that is adjacent in the circumferential or transverse direction.

13. The pneumatic vehicle tire as claimed in claim 7, wherein the projections are arranged in pairs on the block flanks.

14. A pneumatic vehicle tire comprising a tread having at least one row of blocks, which runs around in a circumferential direction of the pneumatic vehicle tire, the at least one row of blocks separated from further profile positives by at least one circumferential groove, and further comprising a plurality of profile blocks within each of the at least one row of blocks, wherein profile blocks are separated from one another in the circumferential direction by transverse grooves and have block flanks which bound the at least one circumferential groove and the transverse grooves, and wherein the block flanks extend at an angle (α) of from 0° to 10° in relation to a radial direction of pneumatic vehicle tire;
wherein projections are formed along the block flanks, radially within surfaces of the block flanks, wherein the projections have surfaces running parallel to the surfaces of the block flanks with edges extending parallel to the block flanks and at a distance (a2) of from 0.3 mm to 1.0 mm, from which end faces bounding the projections run as far as the base of the groove and run at an angle in relation to the radial direction up to 7° greater than the respective block flank, and wherein the projections are arranged in pairs on the block flanks; and,
wherein a distance (a2) of the edges from the block flanks is from 0.4 mm to 0.6 mm, and wherein the surfaces of the projections run at a distance (a1) of from 1.5 mm to 2.5 mm from the respective block surface.

15. The pneumatic vehicle tire as claimed in claim 14, wherein the projections have a longitudinal extent (L1, L2) of from 4 mm to 20 mm in the direction of the extent of the respective transverse groove.

16. The pneumatic vehicle tire as claimed in claim 14, wherein the projections have a longitudinal extent (L1, L2) of from 4 mm to 20 mm in the direction of the extent of the respective circumferential groove.

17. The pneumatic vehicle tire as claimed in claim 14, wherein there is opposite a projection on one block flank of a profile block, a projection on the opposite block flank of a profile block that is adjacent in the circumferential or transverse direction.

18. A pneumatic vehicle tire comprising a tread having at least one row of blocks, which runs around in a circumferential direction of the pneumatic vehicle tire, the at least one row of blocks separated from further profile positives by at least one circumferential groove, and further comprising a plurality of profile blocks within each of the at least one row of blocks, wherein profile blocks are separated from one another in the circumferential direction by transverse grooves and have block flanks which bound the at least one circumferential groove and the transverse grooves, and wherein the block flanks extend at an angle (α) of from 0° to 10° in relation to a radial direction of pneumatic vehicle tire;
wherein projections are formed along the block flanks, radially within surfaces of the block flanks, wherein the projections have surfaces running parallel to the surfaces of the block flanks with edges extending parallel to the block flanks and at a distance (a2) of from 0.3 mm to 1.0 mm, from which end faces bounding the projections run as far as the base of the groove and run at an angle in relation to the radial direction up to 7° greater than the respective block flank, and wherein the projections are arranged in pairs on the block flanks; and,
wherein there is opposite a projection on one block flank of a profile block, a projection on the opposite block flank of a profile block that is adjacent in the circumferential or transverse direction.

19. The pneumatic vehicle tire as claimed in claim 18, wherein a distance (a2) of the edges from the block flanks is from 0.4 mm to 0.6 mm.

20. The pneumatic vehicle tire as claimed in claim 18, wherein the surfaces of the projections run at a distance (a1) of from 1.5 mm to 2.5 mm from the respective block surface.

21. The pneumatic vehicle tire as claimed in claim 18, wherein the projections have a longitudinal extent (L1, L2) of from 4 mm to 20 mm in the direction of the extent of the respective transverse groove.

22. The pneumatic vehicle tire as claimed in claim 18, wherein the projections have a longitudinal extent (L1, L2) of from 4 mm to 20 mm in the direction of the extent of the respective circumferential groove.
